(19) United States
(12) Patent Application Publication
(10) Pub. No.: US 2009/0183887 A1
(43) Pub. Date: Jul. 23, 2009

(54) Power hand tool system with universal flexible shaft and method of operating

(75) Inventors: Brad M. Baber, Joliet, IL (US); Raymond R. Esparza, Chicago, IL (US); Julie M. Esparza, Chicago, IL (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignees: Credo Technology Corporation, Broadview, IL (US); Robert Bosch GmbH, Stuttgart (DE)

(21) Appl. No.: 12/009,433

(22) Filed: Jan. 18, 2008

(51) Int. Cl. B23Q 5/00; B23Q 5/10; B23Q 5/12

(52) U.S. Cl. 173/1; 173/217; 173/216; 173/215

(57) ABSTRACT

The invention provides a rotary tool system and method of operating. In one embodiment, a rotary tool system includes a rotary tool with a rotary motor, an output shaft operatively connected to the motor for transferring rotational force from the motor and a first coupler assembly, a flexible power transmission shaft including a first end portion with a second coupler assembly configured to removably couple with the first coupler assembly, a transfer shaft operatively coupled with the output shaft for receiving rotational force from the output shaft, and a third coupler assembly located at a second end portion of the flexible power transmission shaft and at least one implement, the at least one implement including a fourth coupler assembly configured to removably couple with the second coupler assembly and an input shaft operably connected to the transfer shaft for receiving rotational force from the transfer shaft.

### FIELD OF THE INVENTION

The present invention relates to a power hand tool system and more particularly to a motorized power hand tool system.

### BACKGROUND

Power tools including battery operated tools are well-known. These tools typically include an electric motor having an output shaft that is coupled to a spindle for holding an implement. The implement may be a drill bit, sanding disc, a de-burring implement, or the like. Electrical power is supplied to the electric motor from a power source. The power source may be provided to the power tool through a cord. Alternatively, the power source may be a battery source such as a Ni-Cad or other rechargeable battery that may be de-coupled from the tool to charge the battery and coupled to the tool to provide power.

Such power tools may be designed for a variety of special uses. Relatively small rotary hand tools have been marketed for many years for use in carrying out woodworking and metal working tasks by hobbyists as well as commercial artisans. These small rotary hand tools, like the larger power tools, generally have a motor unit with a rotary output shaft that is adapted to be connected to a number of implements such as sanding implements, rotary cutting implements, planing attachments, filing implements, buffing implements and polishing implements.

The foregoing implements are typically sold separately or as a part of a combined set. In addition to the implements that are used with the rotary tools, various attachments are also available. A common example of an attachment is a cutting guide attachment that is installed onto the rotary tool for use with a cutting implement to guide the cutting path of the rotary tool in a controlled manner relative to a work-piece. Other attachments available include work lights, tool and blade sharpeners, grout removal guides, holders, routing attachments, drilling attachments and shaper tables.

Many of the implements identified above may be provided with a long flexible shaft that transfers the rotary movement of the output shaft of the rotary tool to the implement. The use of a flexible shaft provides a number of advantages. For example, the implement may be much more maneuverable since the additional bulk of the rotary tool motor need not be manipulated. Additionally, the implement may be fashioned within a housing that is better adapted to the manner in which the implement will be gripped when in use.

The provision of an implement with a flexible shaft does, however, incur some disadvantages. For example, the implement cannot be directly connected to the rotary tool. Thus, even when the maneuverability of the flexible shaft is not required, the flexible shaft must still be connected. Alternatively, a user can purchase one implement with a flexible shaft and a second instrument without a flexible shaft. This alternative obviously increases both the cost of a tool set as well as the storage area required for the tools set.

Moreover, the flexible shafts must be accounted for within the storage container. For example, when tool kits are sold, a storage container is frequently provided which is specially formed to both organize the implements and to protect the implements. While providing for one implement with a flexible shaft may not be overly cumbersome within a storage container, the arrangement of a number of different flexible shafts within a single container may become a significant problem when each such shaft is connected to an implement with its own unique storage requirements.

There is a need to reduce the number of redundant implements that must be maintained without losing the flexibility of using an implement either directly connected to a rotary tool or connected to the rotary tool through a flexible shaft. There is a further need to reduce the number of shafts that are needed to provide for the use of various implements with a flexible shaft.

### SUMMARY

Some of the limitations of previously known hand power tools may be overcome by a rotary tool system and method of operating. In one embodiment, a rotary tool system includes a rotary tool with a rotary motor, an output shaft operatively connected to the motor for transferring rotational force from the motor and a first coupler assembly, a flexible power transmission shaft including a first end portion with a second coupler assembly configured to removably couple with the first coupler assembly, a transfer shaft operatively coupled with the output shaft for receiving rotational force from the output shaft, and a third coupler assembly located at a second end portion of the flexible power transmission shaft and at least one implement, the at least one implement including a fourth coupler assembly configured to removably couple with the second coupler assembly and an input shaft operably connected to the transfer shaft for receiving rotational force from the transfer shaft.

In another embodiment, a universal flexible shaft includes a transfer shaft having a first end portion and a second end portion, a first coupler assembly located at the first end portion for removably coupling with a rotary tool and a second coupler assembly located at the second end portion for removably coupling with a rotary tool implement.

One method of operating a rotary tool system includes coupling a first end portion of a transfer shaft assembly to a rotary tool, coupling a second end portion of the transfer shaft assembly to a first implement, transferring rotational movement of the rotating tool to the first implement through the transfer shaft assembly, decoupling the first end portion of the transfer shaft assembly from the rotary tool and decoupling the second end portion of the transfer shaft assembly from the first implement.

### BRIEF DESCRIPTION OF THE DRAWINGS

The present invention may take form in various system and method components and arrangement of system and method components. The drawings are only for purposes of illustrating exemplary embodiments and are not to be construed as limiting the invention.

FIG. 1 depicts a plan perspective view of a flexible shaft assembly and a partial cross-sectional view of a rotary tool in a rotary tool system incorporating features of the present invention;

FIG. 2 depicts a partial cross-sectional view of the male coupler assembly and transfer shaft of the flexible shaft assembly of FIG. 1;

FIG. 3 depicts a perspective view of a sanding implement held by a user and removably coupled with the flexible shaft assembly of FIG. 1 in a rotary tool system;

FIG. 4 depicts a perspective view of the implement of FIG. 3 directly coupled with the rotary tool of FIG. 1;

FIG. 5 depicts a side pan view of a random orbit sander implement with a coupler assembly in the form of an overthrow nut mechanism that can be used with the flexible shaft of FIG. 1 in accordance with features of the present invention;

FIG. 6 is a side cross-sectional view of the random orbit sander of FIG. 5 along with a cross-sectional view of an abrasive pad and retaining screw;

FIG. 7 is a perspective view of the drive shaft of the random orbit sander of FIG. 5 rotationally supported by two bearings which are spaced apart and an eccentric which provides eccentric motion of the sanding media when the random orbit sander is activated.

FIG. 8 is a side plan view of an alternative implement in the form of a reciprocating saw with a coupler assembly that can be coupled to a rotary tool either directly or through a flexible shaft assembly in accordance with features of the present invention;

FIG. 9 depicts a side plan view of the reciprocating saw implement of FIG. 8 with a portion of the housing removed to reveal a drive shaft assembly which includes a planetary gear set to step down the rotation of the and a cam follower assembly to convert the stepped down rotation to a reciprocating axial motion

FIG. 10 depicts a side perspective view of an alternative implement in the form of an orbital sander coupled to a flexible shaft assembly in accordance with features of the present invention;

FIG. 11 depicts a side perspective view of a further alternative implement in the form of an detail sander coupled to a flexible shaft assembly in accordance with features of the present invention; and

FIG. 12 depicts a is a side plan view of a further alternative implement in the form of an handpiece coupled to a flexible shaft assembly in accordance with features of the present invention.

### DESCRIPTION

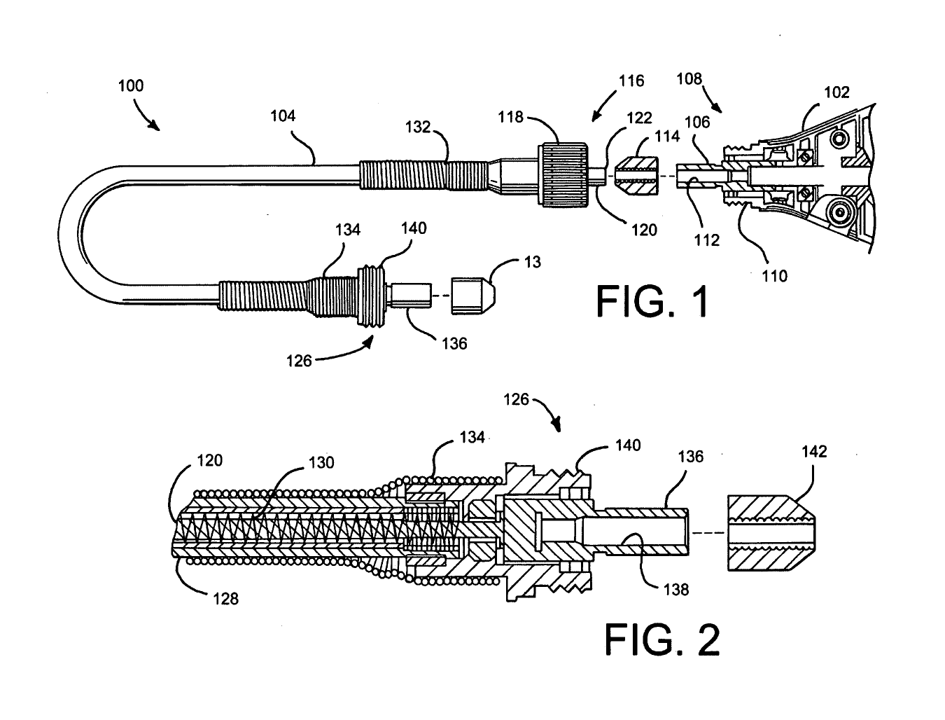

A power tool system generally designated 100 is shown in FIG. 1. In the embodiment of FIG. 1, the power tool system 100 includes a rotary tool 102 and a flexible shaft 104. The rotary tool 102 may be a hand-held, electric tool of the type commercially available under the trademark DREMEL® from Credo Technology Corporation. The rotary tool 102 has an internal electric motor (not shown) which provides a source of rotary power for an axially-oriented output shaft 106. A male coupler assembly 108 includes a threaded coupler 110 and the end portion of the output shaft 106 which includes a recess 112 and which extends outwardly from the threaded coupler 110. A collet nut 114 is configured to fit over the output shaft 106.

The flexible shaft 104 includes a female coupler assembly 116 which is configured to be coupled with the male coupler assembly 108. The female coupler assembly 116 includes a threaded coupler 118 and the end portion 122 of a transfer shaft 120 which extends outwardly from the threaded coupler 118. The transfer shaft 120 extends from the female coupler assembly 116 to a male coupler assembly 126 located at the opposite end of the flexible shaft 104. The transfer shaft 120 is located within a sheath or casing 128 with a coil support 130 disposed between the transfer shaft 120 and the casing 128 as shown in FIG. 2.

The transfer shaft 120 is preferably made from a flexible metal while the casing 128 is preferably made of durable, inexpensive, thermoformable plastic material such as polyvinylchloride (PVC). Other suitable materials for these components are contemplated. The coil support 130 allows the transfer shaft 120 to rotate within the casing 128. Coiled, spring-like bend protectors 132 and 134 are located at the end portions of the casing 128 to restrict the ability of the flexible shaft 104 to bend at the end portions of the casing 128.

The male coupler assembly 126, in this embodiment, is configured in the same manner as the male coupler portion 108. Thus, the male coupler assembly 126 includes an output shaft 136 with a recess 138 and a threaded coupler 140. A collet 142 is configured to fit over the output shaft 136.

Returning to FIG. 1, the end portion 122 of the transfer shaft 120 which extends outwardly from the threaded coupler 118 is configured to fit within the recess 112 of the output shaft 106. Preferably, the recess 112 and the end portion 122 of the transfer shaft 120 are configured such that the end portion 122 of the transfer shaft 120 fits within the recess 112 in a keyed configuration. This may be accomplished, for example, by configuring the end portion 122 of the transfer shaft 120 and the recess 112 to have a common shape (e.g. triangular, rectangular, etc) or by incorporation of a key and slot arrangement. Accordingly, when the female coupler assembly 108 and the male coupler assembly 116 are coupled, the transfer shaft 120 is rotationally engaged with the output shaft 106. Thus, rotation of the output shaft 106 causes rotation of the transfer shaft 116.

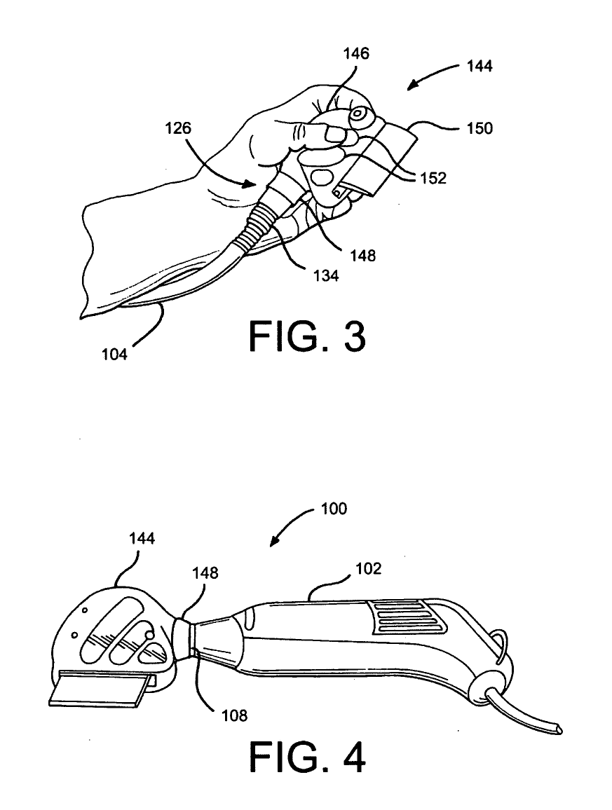

The power tool system 100 further includes an implement 144 shown in FIG. 3 coupled with the flexible shaft 104. The implement 144 is a contour detail sander implement. The implement 144 includes a housing 146, a female coupler assembly 148 and a contoured sanding block 150. The contour sanding block 150 is preferably removably coupled with the implement 144. Thus, a kit may include a number of different sanding blocks of different shapes and sizes that may be interchangeably coupled with the implement 144.

The housing 146 is made from a lightweight material and is shaped to be easily held by a user as shown in FIG. 3. The housing sections are preferably made of a plastic or plastic-like material, such as ABS or glass filled nylon. A number of grip portions 152 are provided on the housing to allow a user to more easily grip the implement 144. The female coupler assembly 148 is configured to mate with the male coupler assembly 126. Thus, the implement 144 includes a drive shaft (not shown) that couples with the transfer shaft 120 through the recess 138 of the output shaft 136 and a threaded portion (not shown) that mates with the threaded coupler 140.

As discussed above, the male coupler assembly 126 is identical to the male coupler assembly 108. Accordingly, the drive shaft (not shown) of the implement 144 also couples with the output shaft 106 through the recess 112 and the threaded portion (not shown) of the implement 144 mates with the threaded coupler 110 to provide the configuration shown in FIG. 4. Thus, the implement 144 may be driven by the output shaft 106 directly or indirectly through the transfer shaft 120.

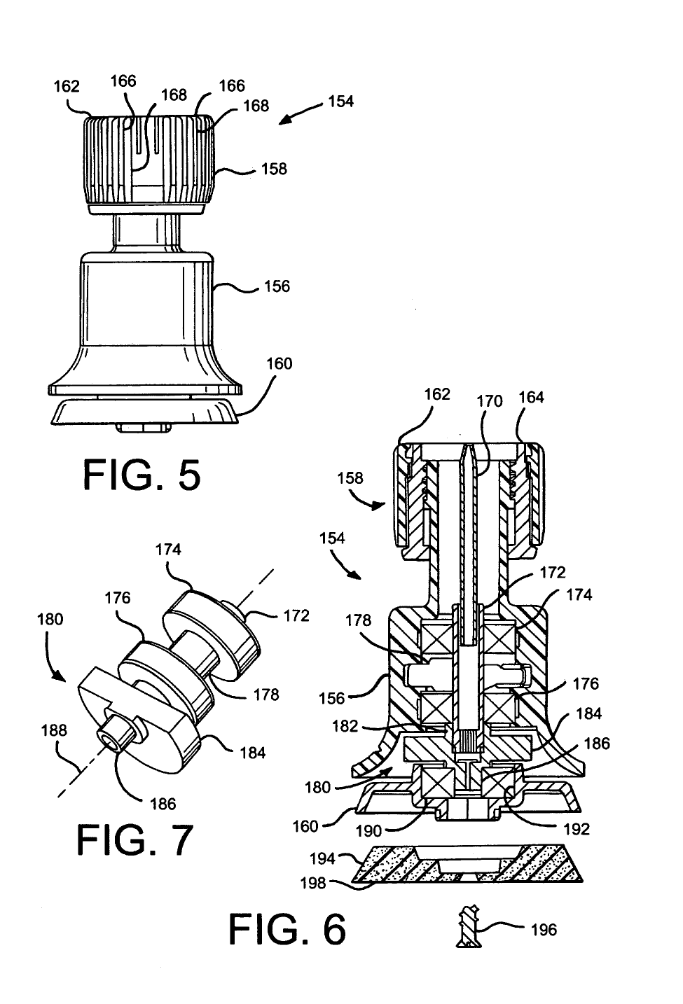

An alternative implement 154 is shown in FIG. 5. The implement 154 is a random orbit sander. The implement 154 includes a housing 156, an overthrow nut mechanism 158, and a pad retainer 160. The overthrow nut mechanism 158 includes an outer sleeve 162 and a nut 164 (see FIG. 6) which is provided in two halves. The outer surface of the sleeve 162 is textured with a series of ridges 166 and grooves 168.

Referring to FIG. 6, an input drive shaft 170 extends within the overthrow nut mechanism 158 and is coupled with a main drive shaft 172. The main drive shaft 172 is rotationally maintained in alignment within the housing 156 by a bearing 174 and a bearing 176 which are separated by a spacer 178.

An eccentric member 180 is connected to the end of the main drive shaft 172. The eccentric member 180 includes a coupling portion 182, a mid portion 184 and an end portion 186. The eccentric member 180 is made of steel. The coupling portion 182 is configured to couple with the main drive shaft 172 via a friction fit. As best seen in FIG. 7, the mid portion 184 is not uniformly shaped about the axis 188 of the main drive shaft 172. The mid portion 184 thus creates an imbalance in the rotation of the main drive shaft 172 about the axis 188.

Returning to FIG. 6, a bearing 190 is located about the end portion 186. The centerline of the bearing 190 is offset from the axis 188 of the main drive shaft 172 to provide eccentric motion. The bearing 190 is located within a well 192 of the pad retainer 160. The pad retainer 160 is configured to hold a pad 194 which is coupled with the pad retainer 160 using a screw 196. In an alternative embodiment, the pad holder and the pad are a single unit. The pad 194 is typically a soft or spongy material that has some give when pressure is applied to reduce gouging of a work piece. The pad 194 has a smooth lower surface 198 upon which an abrasive material may be mounted.

In operation, the implement 154 is mounted to either the rotary tool 102 or the flexible shaft 104. In this example, the implement 154 will be mounted to the flexible shaft 104. Accordingly, the input drive shaft 170 is inserted through the collet 142 and into the recess 138. The overthrow nut mechanism 158, which is a female coupler assembly, is then used to firmly couple the implement 154 with the male coupler assembly 126 of the flexible shaft 104. As a user rotates the outer sleeve 162 in a first direction, the threads of the nut 164 engage the threads of the threaded coupler 140. Continued rotation of the sleeve 162 forces the threads of the nut 164 to firmly engage the threads of the threaded coupler 140, thereby rotationally coupling the input drive shaft 170 with the output shaft 136 as the nut 164 compresses the collet 142 to bind the input drive shaft 170 within the recess 138.

The flexible shaft 104 is similarly mounted to the rotary tool 102. The end portion 122 of the transfer shaft 120 is inserted through the collet 114 and into the recess 112. The female coupler assembly 116 is then used to firmly couple the flexible shaft 104 with the male coupler assembly 108 of the rotary tool 102. As a user rotates the threaded coupler 118 in a first direction, the threads of the threaded coupler 118 engage the threads of the threaded coupler 110. Continued rotation of the threaded coupler 118 forces the threads of the threaded coupler 118 to firmly engage the threads of the threaded coupler 110, thereby rotationally coupling the transfer shaft 120 with the output shaft 106 as the threaded coupler 118 compresses the collet 114 to bind the end portion 122 of the transfer shaft 120 within the recess 112.

Next, the rotary tool 102 is energized. In this embodiment, energization is accomplished using a switch on the rotary tool 102. In alternative embodiments, energization of the rotary tool may be accomplished using a switch on the implement. Energization of the rotary tool 102 causes the motor (not shown) to rotate which in turn causes the output shaft 106 to rotate. The output shaft 106 is coupled with the transfer shaft 120, preferably through the use of a keyed configuration, while the transfer shaft 120 is rotatably supported by the coil support 130. Accordingly, rotation of the output shaft 106 causes the transfer shaft 120 to rotate.

The transfer shaft 120 is coupled, through the output shaft 136, with the input drive shaft 170, preferably through the use of a keyed configuration. Accordingly, rotation of the transfer shaft 120 causes the input drive shaft 170 to rotate. The input drive shaft 170 is coupled with the main drive shaft 172 which is rotatably supported by the bearings 174 and 176. Thus, rotation of the input drive shaft 170 is transferred to the main drive shaft 172 which in turn causes rotation of the eccentric member 180.

The eccentric member 180 is operatively coupled to the pad holder 194 through the bearing 190. Thus, rotation of the eccentric member 180 provides the orbital motion for the pad holder 194. The centerline of the bearing 190, however, is offset from the axis 188 of the main drive shaft 172 and the pad holder 194 is free to rotate about the bearing 190. Accordingly, movement of the pad holder 194 is not purely orbital. This eccentric movement creates the random orbital movement also known in the trade as dual action.

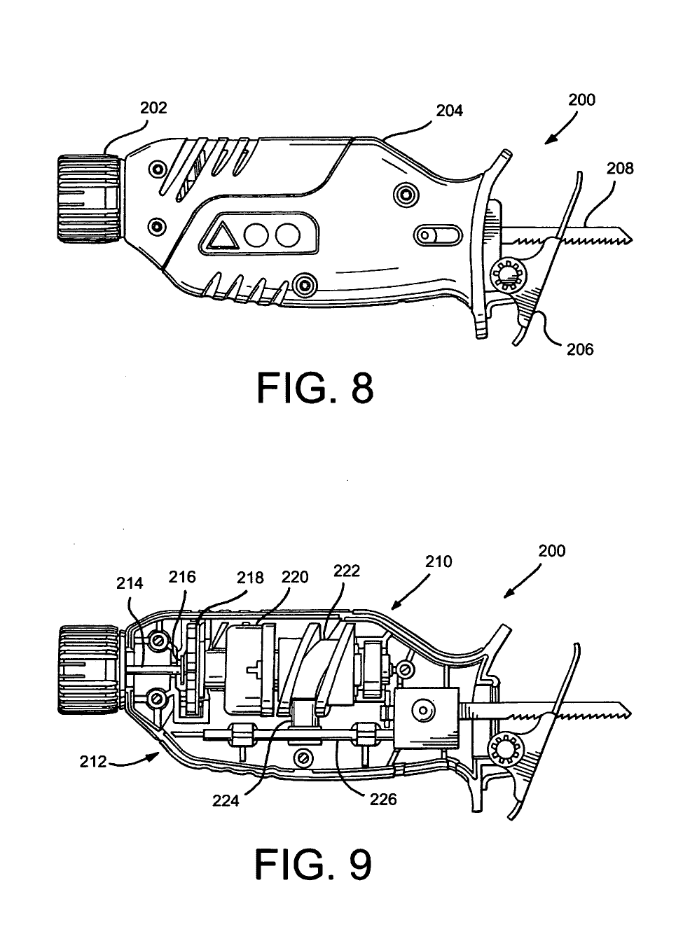

The rotational speed of a rotary tool such as the rotary tool 102 can be several thousand rounds per minute. For some applications, the cycling of the particular instrument is preferably much lower. Additionally, some instruments require reciprocating motion. The implement 200 shown in FIG. 8 is a reciprocating saw that is configured to both convert rotational movement to reciprocating movement and to reduce the frequency of the movement. The implement 200 includes an overthrow nut mechanism 202, a main housing 204 and a guide foot 206 which supports the implement 200 as a saw blade 208 is used to engage a work piece.

The implement 200 includes a drive train assembly 210 and a cam follower assembly 212 shown in FIG. 9. The drive train assembly 210 includes a drive coupling shaft 214 with an annular outwardly extending flange 216 for limiting axial movement of the coupling shaft 214 relative to a fan blade 218. The coupling shaft 214 is operably connected to a planetary gear set 220. The planetary gear set 220 is operably connected to a threaded cylinder 222. The cam follower assembly 212 includes a knob 224 that is fixedly attached to the blade 208 through a shaft 226. The knob 224 is entrapped between adjacent threads on the threaded cylinder 222.

The planetary gear set 220 reduces the rotational speed between the input and the output of the planetary gear set 220 as more fully detailed in U.S. Patent Publication No. 2005/0252670, published Nov. 17, 2005, the teaching of which is herein incorporated in its entirety by reference. Additionally, the threaded cylinder 222 cooperates with the knob 224 to convert rotational movement to reciprocating movement. More specifically, as the threaded cylinder 222 rotates, the knob 224 is forced to move in an axial direction, thereby creating a reciprocating movement.

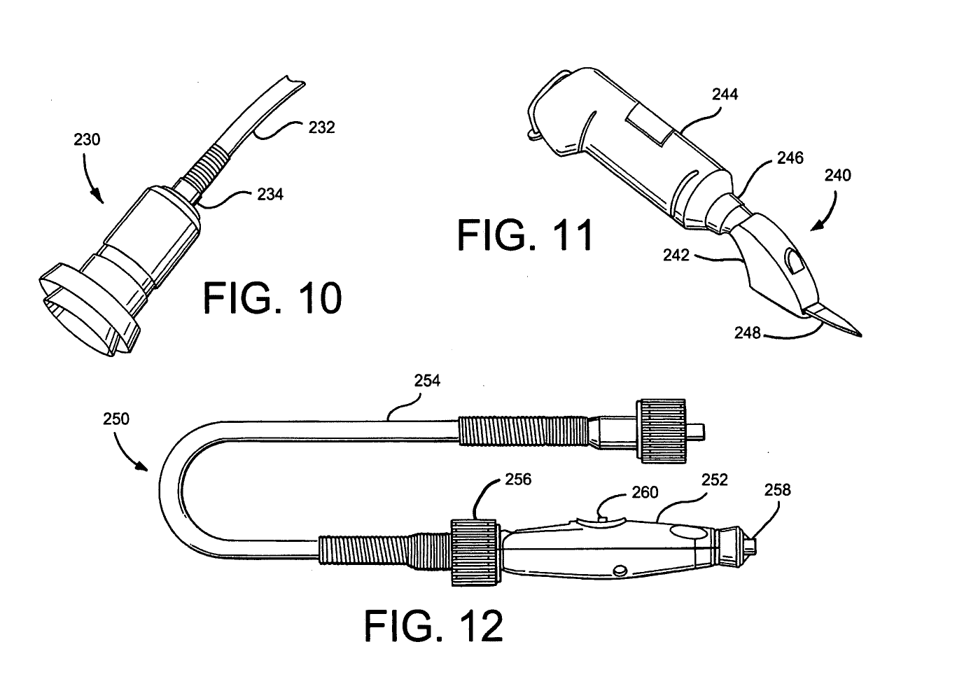

The features identified above may be provided in a number of different combinations for a variety of implements. Referring to FIG. 10, an implement 230 is shown coupled with a flexible shaft 232. The implement 230 is an orbital sander with a female coupler assembly 234. A pad holder 236 is configured to be coupled with, for example, sand paper. The pad holder 236 may be rotated directed from a shaft (not shown) coupled with and output shaft (not shown) of the flexible shaft 232. Alternatively, the rotational speed of the pad holder may be reduced by the provision of planetary gears or other mechanisms such as gears for reducing the rotational speed. The female coupler assembly 234 allows the implement 230 to be directly coupled to a rotary tool.

Referring to FIG. 11, a power tool system 240 includes an implement 242 coupled with a rotary tool 244. The implement 242 is a detail sander with a female coupler assembly 246. An abrasive component 248 is removably coupled with the implement 242. Preferably, a number of different abrasive components capable of being removably coupled with the implement 242 and having different sizes, shapes and abrasive qualities are provided in the power tool system 240. The sanding component 248 is driven in a reciprocating axial motion using a gear system (not shown). The female coupler assembly 246 allows the implement 242 to be directly coupled to a flexible shaft (not shown) that is provided with the power tool system 240.

FIG. 12 shows a power tool system 250 which includes an implement 252 coupled with a flexible shaft 254. The implement 252 is a hand piece with a female coupler assembly 256. The female coupler assembly 256 allows the implement 252 to be directly coupled to a main rotary tool (not shown) that is provided with the power tool system 250. While a threaded coupler is preferably incorporated into the female coupler assembly 256, it is contemplated that other types of fastening connections may be used, including bayonet-type lugs, clips and other repeatable and releasable positive fastening connections.

A working attachment or bit 258, may be coupled with an attachment such as, but not restricted to a drill bit, a polishing disk, a grinding wheel, a sanding wheel, a cutting wheel or bit, a wire brush, a saw or other known rotary tool attachment. Preferably, one or more attachments are provided in the power tool system 250. The implement 252 is designed for enhancing user control of the rotary action of an attachment coupled with the bit 258 for delicate and/or difficult to reach operations. As such, the implement 252 is easier and lighter to hold than the main rotary tool (not shown).

The implement 252 further includes a lock-out activator 260 which can temporarily lock the bit 258 from rotation. The lock-out activator is configured such that a single hand may be used to hold the implement 250 and to operate the lock-out activator 260. This operation is helpful when exchanging working attachments. In one embodiment, the lock-out activator 260 is preferably a single pin or button for releasable engagement with a drive shaft coupled with the bit 258.

In operation, a user merely depresses the lock-out activator 260 into the implement 250. The lock-out activator 260 may be outwardly biased by a spring (not shown) so as to hold an actuator out of engagement with the drive shaft or the bit 258. In one embodiment, the spring is a flat spring formed into a “C”-shape, and defines a gap facing away from the lock-out activator 260. Thus, depression of the lock-out activator 260 interferes with rotation of the bit 258.

While the present invention has been illustrated by the description of exemplary processes and system components, and while the various processes and components have been described in considerable detail, the applicant does not intend to restrict or in any limit the scope of the appended claims to such detail. Additional advantages and modifications will also readily appear to those skilled in the art. The invention in its broadest aspects is therefore not limited to the specific details, implementations, or illustrative examples shown and described. Accordingly, departures may be made from such details without departing from the spirit or scope of the general inventive concept disclosed herein.

1. A rotary tool system comprising:
a rotary tool with a rotary motor, an output shaft operatively connected to the motor for transferring rotational force from the motor and a first coupler assembly;
a flexible power transmission shaft including a first end portion with a second coupler assembly configured to removably couple with the first coupler assembly, a transfer shaft operably coupled with the output shaft for receiving rotational force from the output shaft, and a third coupler assembly located at a second end portion of the flexible power transmission shaft; and
at least one implement, the at least one implement including a fourth coupler assembly configured to removably couple with the third coupler assembly and an input shaft operably connected to the transfer shaft for receiving rotational force from the transfer shaft.

2. The rotary tool system of claim 1, wherein the at least one implement comprises a plurality of implements.

3. The rotary tool system of claim 2, wherein the plurality of implements comprises one or more implements selected from the group consisting of:
a rotary sander;
a handpiece;
a rotary grinder; and
a random orbital sander.

4. The rotary tool system of claim 1, wherein the fourth coupler assembly is further configured to removably couple with the first coupler assembly.

5. The rotary tool system of claim 1, wherein the third coupler assembly is configured to removably couple with the second coupler assembly.

6. The rotary tool system of claim 1, wherein the input shaft is operably connected to the transfer shaft using a keyed configuration.

7. The rotary tool system of claim 6, wherein the transfer shaft is operably coupled with the output shaft using a keyed configuration.

8. The rotary tool system of claim 1, wherein the at least one implement comprises:
a planetary gear set.

9. The rotary tool system of claim 8, wherein the at least one implement is configured to convert rotational movement of the input shaft to a reciprocating movement of a drive shaft.

10. A universal flexible shaft comprising:
a transfer shaft having a first end portion and a second end portion;
a first coupler assembly located at the first end portion for removably coupling with a rotary tool; and
a second coupler assembly located at the second end portion for removably coupling with a rotary tool implement.

11. The universal flexible shaft of claim 10, wherein the first coupler assembly and the second coupler assembly are configured such that the first coupler assembly can be removably coupled with the second coupler assembly.

12. The universal flexible shaft of claim 11, wherein:
the first coupler assembly comprises a threaded coupler and an end portion of the transfer shaft; and
the second coupler assembly comprises a threaded coupler and an output shaft operably connected to the transfer shaft, the output shaft configured such that the output shaft can be mated with the end portion of the transfer shaft.

13. The universal flexible shaft of claim 12, wherein the end portion of the transfer shaft and the output shaft are configured such that they can be mated in a keyed configuration.

14. A method of operating a rotary tool system comprising:
coupling a first end portion of a transfer shaft assembly to a rotary tool;
coupling a second end portion of the transfer shaft assembly to a first implement;
transferring rotational movement of the rotating tool to the first implement through the transfer shaft assembly;
decoupling the first end portion of the transfer shaft assembly from the rotary tool; and
decoupling the second end portion of the transfer shaft assembly from the first implement.

15. The method of claim 14, further comprising:
coupling the second end portion of the transfer shaft assembly to a second implement;
transferring rotational movement of the rotating tool to the second implement through the transfer shaft assembly; and
decoupling the second end portion of the transfer shaft assembly from the second implement.

16. The method of claim 14, wherein coupling a first end portion of the transfer shaft assembly to the rotary tool comprises;
threadedly engaging a transfer shaft assembly coupler assembly with a coupler assembly on the rotary tool.

17. The method of claim 16, further comprising:
threadedly engaging a coupler assembly on the first implement with the coupler assembly on the rotary tool.

18. The method of claim 16, wherein coupling a first end portion of a transfer shaft assembly to a rotary tool further comprises:
inserting a first end portion of a transfer shaft into a recess in a rotary tool output shaft.
